(19) United States
(12) Patent Application Publication
(10) Pub. No.: US 2025/0329846 A1
(43) Pub. Date: Oct. 23, 2025

(54) ELECTRIC STORAGE APPARATUS

(71) Applicant: TOYOTA JIDOSHA KABUSHIKI KAISHA, Aichi-ken (JP)

(72) Inventors: Naoya KAWAMOTO, Nisshin-shi (JP); Shigeyuki INOUE, Toyota-shi (JP); Nobuyoshi FUJIWARA, Nagoya-shi (JP); Kenta KIMURA, Toyota-shi (JP)

(73) Assignee: TOYOTA JIDOSHA KABUSHIKI KAISHA, Aichi-ken (JP)

(21) Appl. No.: 19/176,157

(22) Filed: Apr. 11, 2025

(30) Foreign Application Priority Data
Apr. 17, 2024 (JP) 2024-066913

(51) Int. Cl. H01M 50/242; H01M 50/204; H01M 50/249; H01M 50/271; H01M 50/289

(52) U.S. Cl. CPC H01M 50/242; H01M 50/204; H01M 50/249; H01M 50/271; H01M 50/289

(57) ABSTRACT

The size of an electric storage apparatus is reduced. An electric storage apparatus according to the present disclosure includes: a first cover; a plurality of battery cells including a pair of electrode terminals disposed above the first cover; a reinforcement member disposed between the plurality of battery cells; and a second cover disposed below the first cover, in which the electric storage apparatus includes a first connection member configured to connect the first cover to the second cover, the first connection member being disposed between the first cover and the second cover, and at least a part of the first connection member overlaps with the reinforcement member as viewed from an up-and-down direction.

### CROSS REFERENCE TO RELATED APPLICATIONS

This application is based upon and claims the benefit of priority from Japanese patent application No. 2024-66913, filed on Apr. 17, 2024, the disclosure of which is incorporated herein in its entirety by reference.

### BACKGROUND

The present disclosure relates to an electric storage apparatus.

For example, the electric storage apparatus disclosed in Patent Literature 1 includes a tray in which an opening is formed, battery cells housed in the tray, a sealing plate that seals the opening of the tray, and a protective plate disposed under the tray. Further, in the electric storage apparatus disclosed in Patent Literature 1, electrode terminals disposed on the sides of the battery cells are connected to a wiring box through the sealing plate.
[Patent Literature 1] Published Japanese Translation of PCT International Publication for Patent Application, No. 2023-530010

### SUMMARY

The applicant has found the following problem. In the electric storage apparatus disclosed in Patent Literature 1, for example, when an impact is applied to the electric storage apparatus from below, it is necessary to secure a space between a protective plate and a tray where the protective plate is deformed by the impact, and thus there is a problem that the size of the electric storage apparatus increases.

The present disclosure in which the size of an electric storage apparatus is reduced has been made so as to overcome the above-described problem.

An electric storage apparatus according to an aspect of the present disclosure includes:
a first cover;
a plurality of battery cells including a pair of electrode terminals disposed above the first cover, one of the pair of electrode terminals being disposed in one of a pair of surfaces that face each other in a first direction and the other of the pair of electrode terminals being disposed on the other one of the surfaces;
a reinforcement member disposed below the electrode terminals and between the plurality of battery cells; and
a second cover disposed below the first cover, in which
the electric storage apparatus includes a first connection member configured to connect the first cover to the second cover, the first connection member being disposed between the first cover and the second cover, and
at least a part of the first connection member overlaps with the reinforcement member as viewed from an up-and-down direction.

In the above-described electric storage apparatus,
the reinforcement member preferably extends in a second direction perpendicular to the first direction and the up-and-down direction,
the first connection member preferably includes a first protrusion part extending in the second direction and protruding in the up-and-down direction, and
a width dimension of the first protrusion part is preferably the same as or greater than a width dimension of the reinforcement member.

In the above-described electric storage apparatus, an end part of the first protrusion part in the first direction preferably overlaps with an end part of the reinforcement member in the first direction as viewed from the up-and-down direction.

The above-described electric storage apparatus preferably includes an intermediate member disposed between at least some of the battery cells arranged in the second direction perpendicular to the first direction and the up-and-down direction,
in which the intermediate member preferably protrudes in the first direction with respect to the battery cells.

The above-described electric storage apparatus preferably includes a second connection member configured to connect the first cover to the second cover, the second connection member being disposed between the first cover and the second cover,
in which at least a part of the second connection member preferably overlaps with the intermediate member as viewed from the up-and-down direction.

In the above-described electric storage apparatus,
the intermediate member preferably extends in the first direction,
the second connection member preferably includes a second protrusion part extending in the first direction and protruding in the up-and-down direction, and
a width dimension of the second protrusion part is preferably the same as or greater than a width dimension of the intermediate member.

In the above-described electric storage apparatus, an end part of the second protrusion part in the second direction preferably overlaps with an end part of the intermediate member in the second direction as viewed from the up- and -down direction.

In the above-described electric storage apparatus, an elastic member is preferably disposed between the first cover and the second connection member.

According to the present disclosure, the size of an electric storage apparatus is reduced.

The above and other objects, features and advantages of the present disclosure will become more fully understood from the detailed description given hereinbelow and the accompanying drawings.

### BRIEF DESCRIPTION OF DRAWINGS

FIG. 1 is a diagram showing a state in which an electric storage apparatus according to an embodiment is mounted on a vehicle;

FIG. 2 is an exploded view showing the electric storage apparatus according to the embodiment in a simplified manner;

FIG. 3 is a diagram for explaining an arrangement of a reinforcement member, a lower case, a first connection member, and a share panel in the electric storage apparatus according to the embodiment;

FIG. 4 is an X-Z cross-sectional view of the electric storage apparatus according to the embodiment;

FIG. 5 is a Y-Z cross-sectional view of the electric storage apparatus taken along a line V-V shown in FIG. 4;

FIG. 6 is a Y-Z cross-sectional view of the electric storage apparatus taken along a line VI-VI shown in FIG. 4; and

FIG. 7 is a diagram for explaining an arrangement of the first connection member and a second connection member of the electric storage apparatus according to the embodiment.

### DESCRIPTION OF EMBODIMENTS

Specific embodiments to which the present disclosure is applied will be described hereinafter in detail with reference to the drawings. However, the present disclosure is not limited to the following embodiments. Further, for the clarification of the description, the following descriptions and drawings are simplified as appropriate. Note that the following description will be given using a three-dimensional (XYZ) coordinate system in order to clarify the description.

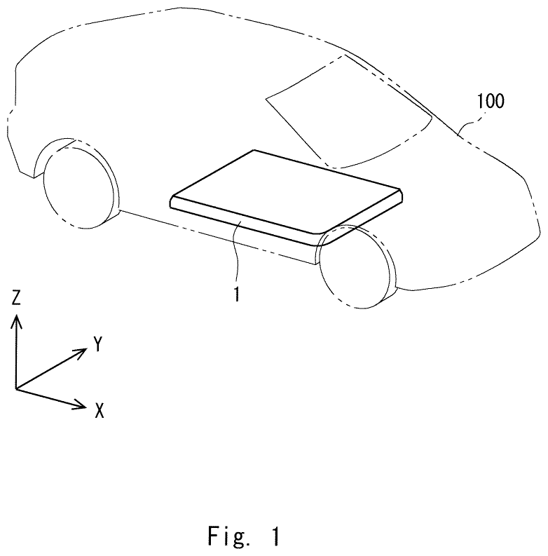

FIG. 1 is a diagram showing a state in which an electric storage apparatus according to this embodiment is mounted on a vehicle. As shown in FIG. 1, for example, an electric storage apparatus 1 is suitably used as an electric storage apparatus mounted on a vehicle 100. In FIG. 1, the X-axis positive side is a front side of the vehicle 100, and the X-axis negative side is a rear side of the vehicle 100. The Y-axis positive side is a left side of the vehicle 100, and the Y-axis negative side is a right side of the vehicle 100. The Z-axis positive side is an upper side of the vehicle 100, and the Z-axis negative side is a lower side of the vehicle 100. That is, it is assumed that the vehicle 100 is disposed in a horizontal plane.

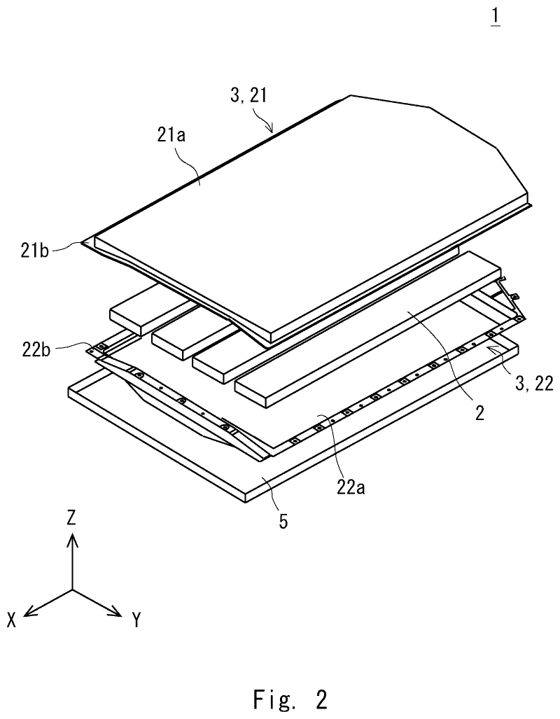

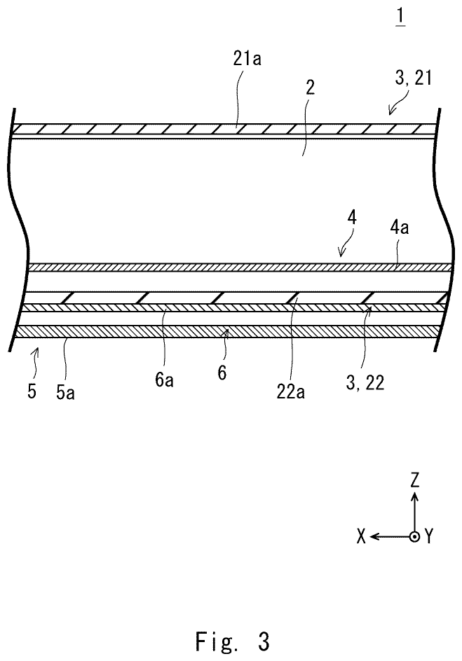

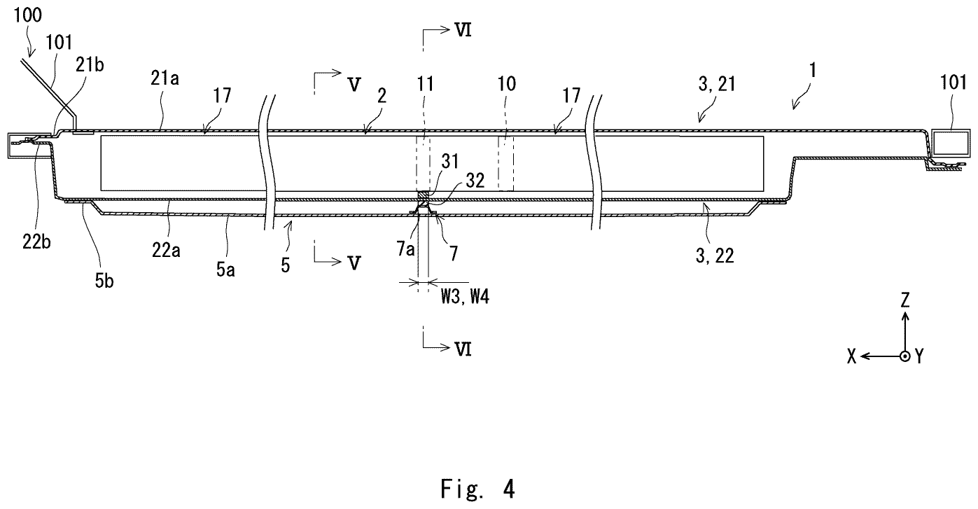

FIG. 2 is an exploded view showing the electric storage apparatus according to this embodiment in a simplified manner. FIG. 3 is a diagram for explaining an arrangement of a reinforcement member, a lower case, a first connection member, and a share panel in the electric storage apparatus according to this embodiment. FIG. 4 is an X-Z cross-sectional view of the electric storage apparatus according to this embodiment.

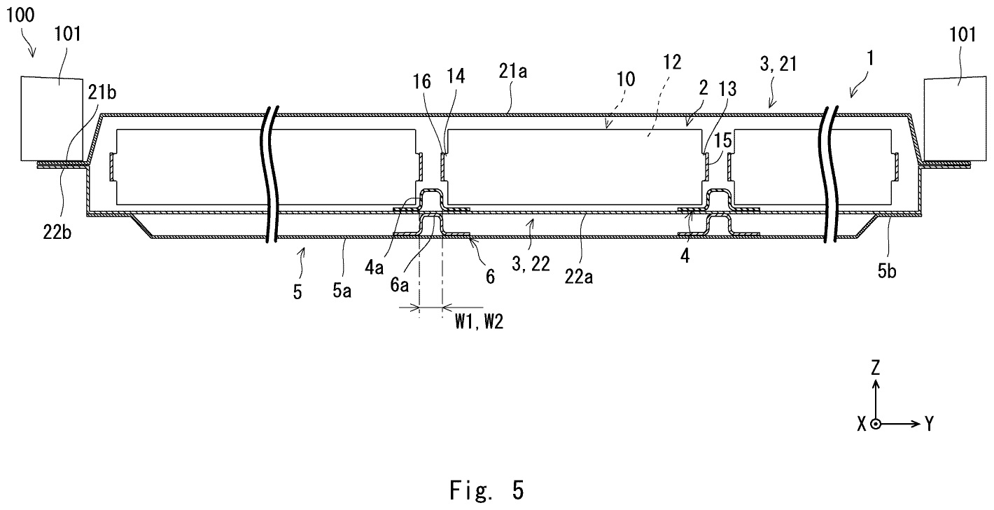

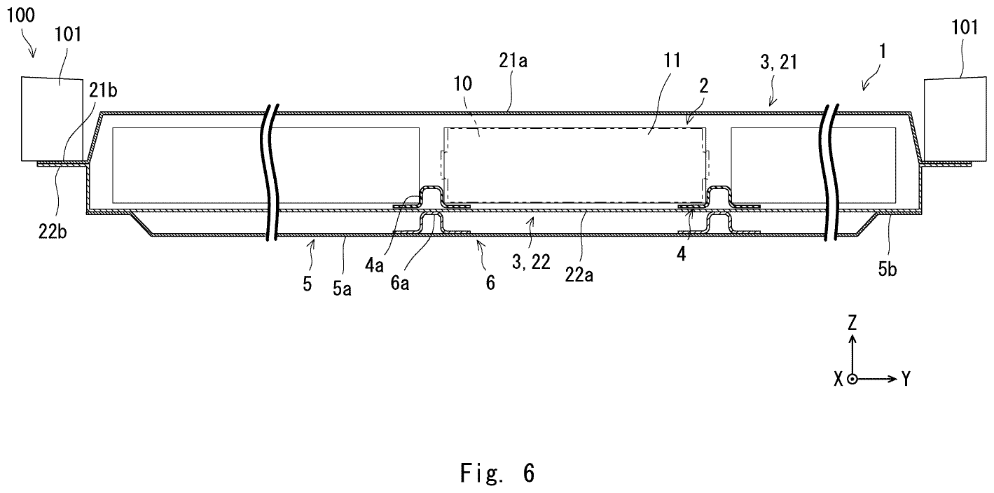

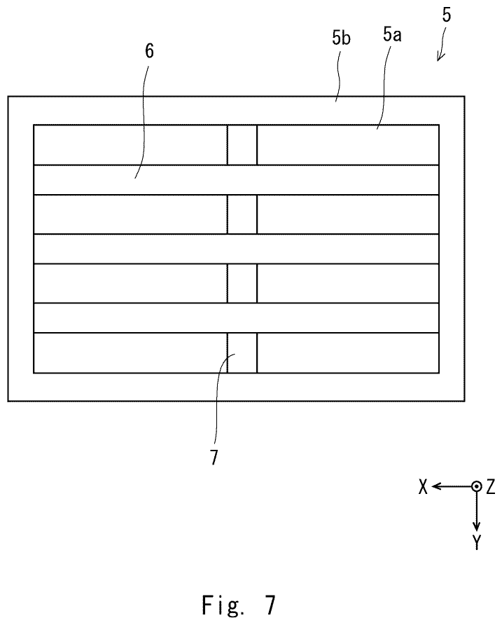

FIG. 5 is a Y-Z cross-sectional view of the electric storage apparatus taken along a line V-V shown in FIG. 4. FIG. 6 is a Y-Z cross-sectional view of the electric storage apparatus taken along a line VI-VI shown in FIG. 4. FIG. 7 is a diagram for explaining an arrangement of the first connection member and a second connection member of the electric storage apparatus according to this embodiment.

As shown in FIGS. 2 to 7, the electric storage apparatus 1 includes battery modules 2, a pack case 3, reinforcement members 4, a share panel (a second cover) 5, a first connection member 6, and a second connection member 7.

Each of the battery modules 2 includes a plurality of battery cells 10 and an intermediate member 11 as shown by imaginary lines in FIG. 4. Each of the battery cells 10 comprises, for example, an electrode body housed inside a battery case 12 as shown in FIG. 5.

For example, as shown in FIG. 5, a first electrode terminal 13, which is one of a positive electrode terminal and a negative electrode terminal, is provided in an end part of the battery case 12 on the Y-axis positive side thereof, and a second electrode terminal 14, which is the other of the positive electrode terminal and the negative electrode terminal, is provided in an end part of the battery case 12 on the Y-axis negative side thereof.

The battery cells 10 are stacked in the X-axis direction so that the positive electrode terminal and the negative electrode terminal are disposed alternately in the X-axis direction (a second direction) on each of the Y-axis positive side and the Y-axis negative side of the battery module 2. Further, the first electrode terminals 13 adjacent to each other in the X-axis direction are electrically connected through a first bus bar 15 on the Y-axis positive side of the battery module 2, and the second electrode terminals 14 adjacent to each other in the X-axis direction are electrically connected through a second bus bar 16 on the Y-axis negative side of the battery module 2.

Thus, the plurality of battery cells 10 are electrically connected to each other in series. As shown in FIG. 4, the plurality of battery cells 10 described above form battery cell sets 17, and the battery cell sets 17 are arranged in the X-axis direction. For example, in the example shown in FIG. 4, two of the battery cell sets 17 are arranged in the X-axis direction.

As shown in FIG. 4, the intermediate member 11 is disposed between the battery cell sets 17 adjacent to each other in the X-axis direction. As shown in FIG. 6, the intermediate member 11 has substantially the same shape as that of the battery case 12 for the battery cells 10, and has a plate body substantially parallel to the YZ plane. That is, the intermediate member 11 extends in the Y-axis direction (the first direction). The intermediate member 11 may be, for example, a hollow extrusion member made of aluminum or a solid rigid member made of resin.

The above-described intermediate member 11 and battery cell sets 17, for example, may be restrained in the X-axis direction, thereby forming the battery module 2. Note that, as shown in FIG. 6, the intermediate member 11 may protrude closer to the Y-axis positive side and the Y-axis negative side than the battery cells 10 do as viewed from the X-axis direction, the detailed functions of which member will be described later.

As shown in FIGS. 2 to 6, the pack case 3 houses the battery modules 2. The pack case 3 includes an upper case 21 and a lower case (a first cover) 22. The upper case 21 includes, for example, a housing part 21a which is configured so as to rise up toward the Z-axis positive side and includes an internal space in which the battery modules 2 can be housed, and a flange part 21b which protrudes outward from the periphery of the housing part 21a.

As shown in FIGS. 2 to 6, the lower case 22 includes, for example, a housing part 22a which is recessed toward the Z-axis negative side and includes an internal space in which the battery module 2 can be housed, and a flange part 22b which protrudes outward from the periphery of the housing part 22a.

The flange part 21b of the upper case 21 and the flange part 22b of the lower case 22 are joined to each other by an adhesive member while the battery modules 2 disposed at predetermined intervals in the Y-axis direction are housed inside the housing part 21a of the upper case 21 and the housing part 22a of the lower case 22 described above. Note that, as shown in FIG. 4, a first elastic member 31 such as a urethane foam sheet may be disposed between the intermediate member 11 and the housing part 22a of the lower case 22.

The reinforcement member 4 is a rigid member which, when a load in the X-axis direction is input to the electric storage apparatus 1, receives the load. As shown in FIGS. 3 and 5, the reinforcement member 4 is disposed between each adjacent pair of the battery modules 2 adjacent in the Y-axis direction in a space on the Z-axis negative side of the first bus bar 15 and the second bus bar 16 that are positioned opposite to each other along the Y-axis direction, and extends in the X-axis direction.

As shown in FIGS. 5 and 6, for example, the reinforcement member 4 has a substantially hat shape including a protrusion part 4a which protrudes toward the Z-axis positive side as viewed from the X-axis direction, and an end part of the reinforcement member 4 on the Z-axis negative side thereof is fixed to a surface of the housing part 22a of the lower case 22 on the Z-axis positive side thereof.

Note that, as shown in FIGS. 5 and 6, the protrusion part 4a of the reinforcement member 4, for example, is disposed between each adjacent pair of the battery modules 2 adjacent in the Y-axis direction. However, the shape of the reinforcement member 4 is not limited, and may be any shape that is long in the X-axis direction.

For example, an end part of the reinforcement member 4 on the X-axis positive side thereof may reach the vicinity of an end part of the battery module 2 on the X-axis positive side thereof, and an end part of the reinforcement member 4 on the X-axis negative side thereof may reach the vicinity of an end part of the battery module 2 on the X-axis negative side thereof.

Note that, as viewed from the Z-axis direction, the reinforcement member 4 may overlap with at least a part of the first bus bar 15 and the second bus bar 16 that are positioned opposite to each other along the Y-axis direction. Thus, a space on the Z-axis negative side of the first bus bar 15 and the second bus bar 16 that are positioned opposite to each other along the Y-axis direction can be effectively used, and hence it is possible to contribute to the reduction of the size of the battery module 2.

As shown in FIGS. 3 to 6, the share panel 5 covers the lower case 22 from the Z-axis negative side thereof. The share panel 5 includes, for example, a recessed part 5a recessed toward the Z-axis negative side thereof in order to secure a space where the share panel 5 is deformed toward the Z-axis positive side thereof, and a flange part 5b which protrudes outward from the periphery of the recessed part 5a. Further, the flange part 5b of the share panel 5 is fixed, for example, to a peripheral part of the lower case 22.

As shown in FIG. 5, the first connection member 6 is disposed between the lower case 22 and the share panel 5 so that at least a part of the first connection member 6 overlaps with the reinforcement member 4 as viewed from the Z-axis direction, and connects the share panel 5 to the lower case 22. The first connection member 6, for example, has a hat shape including a protrusion part (a first protrusion part) 6a which protrudes toward the Z-axis positive side as viewed from the X-axis direction, and as shown in FIG. 7, it extends in the X-axis direction.

As shown in FIG. 5, an end part of the first connection member 6 on the Z-axis negative side thereof is fixed to a surface of the recessed part 5a of the share panel 5 on the Z-axis positive side thereof. Thus, the first connection member 6 can function as a reinforcing member of the share panel 5. Further, an end part of the protrusion part 6a of the first connection member 6 on the Z-axis positive side thereof is in contact with a surface of the housing part 22a of the lower case 22 on the Z-axis negative side thereof.

Thus, when an impact is applied to the share panel 5 from the Z-axis negative side thereof, the transmission of the impact at the recessed part 5a of the share panel 5 can be stopped by the first connection member 6, and hence the amount of an Energy Absorption (EA) stroke can be reduced.

Therefore, a space where the share panel 5 is deformed in the Z-axis direction when an impact is applied to the share panel 5 can be made smaller than that of an ordinary electric storage apparatus, and thus it is possible to contribute to the reduction of the size of the electric storage apparatus 1. Moreover, the bending rigidity of the share panel 5 around the Y-axis can be improved, and thus the thickness of the share panel 5 can be reduced. As a result, the weight of the electric storage apparatus 1 can be reduced.

Further, when an impact is applied to the share panel 5 from the Z-axis negative side thereof, a load due to the impact can be released to the reinforcement members 4 through the first connection member 6. Therefore, it is not required to make the share panel 5 rigid like a share panel of an ordinary electric storage apparatus, and thus the thickness of the share panel 5 can be reduced. As a result, the weight of the electric storage apparatus 1 can be reduced.

Note that, for example, the share panel 5 and the first connection member 6 may be fixed to the reinforcement member 4 by screwing bolts inserted into the share panel 5, the first connection member 6, and the lower case 22 through through holes formed therein into welded nuts housed in the reinforcement members 4. Thus, the vibration of the share panel 5 can be suppressed.

Further, for example, as shown in FIG. 5, a width dimension W1 of the end part of the protrusion part 6a of the first connection member 6 on the Z-axis positive side thereof in the Y-axis direction may be the same as or greater than a width dimension W2 of an end part of the protrusion part 4a of the reinforcement member 4 on the Z-axis negative side thereof in the Y-axis direction. That is, the width dimensions W1 and W2 are lengths in the Y-axis direction perpendicular to the X-axis direction and the Z-axis direction. Thus, when an impact is applied to the share panel 5 from the Z-axis negative side thereof, a load due to the impact can be reliably released to the reinforcement members 4 through the first connection member 6.

More preferably, for example, as shown in FIG. 5, the width dimension W1 of the end part of the protrusion part 6a of the first connection member 6 on the Z-axis positive side thereof in the Y-axis direction may be substantially the same as the width dimension W2 of the end part of the protrusion part 4a of the reinforcement member 4 on the Z-axis negative side thereof in the Y-axis direction.

Note that, as shown in FIG. 5, as viewed from the Z-axis direction, an end part of the protrusion part 6a of the first connection member 6 on the Y-axis positive side thereof may substantially overlap with an end part of the protrusion part 4a of the reinforcement member 4 on the Y-axis positive side thereof, and an end part of the protrusion part 6a of the first connection member 6 on the Y-axis negative side thereof may substantially overlap with an end part of the protrusion part 4a of the reinforcement member 4 on the Y-axis negative side thereof.

Thus, as viewed from the Z-axis direction, the protrusion part 6a of the first connection member 6 is disposed between each adjacent pair of the battery modules 2 adjacent in the Y-axis direction, and when an impact is applied to the share panel 5 from the Z-axis negative side thereof, the battery cells 10 can be prevented from being pushed up by the first connection members 6.

Note that the end part of the protrusion part 6a of the first connection member 6 on the Z-axis positive side thereof may be in contact with the surface of the housing part 22a of the lower case 22 on the Z-axis negative side thereof through a second elastic member (not shown) such as a urethane foam sheet, or may be directly in contact with the surface of the housing part 22a of the lower case 22 on the Z-axis negative side thereof.

As shown in FIGS. 4 and 6, the second connection member 7 is disposed between the lower case 22 and the share panel 5 so that at least a part of the second connection member 7 overlaps with the intermediate member 11 as viewed from the Z-axis direction, and it connects the share panel 5 to the lower case 22.

As shown in FIG. 4, the second connection member 7, for example, has a hat shape including a protrusion part (a second protrusion part) 7a which protrudes toward the Z-axis positive side as viewed from the X-axis direction. Further, as shown in FIG. 7, the second connection member 7 extends in the Y-axis direction and is disposed so that it does not interfere with the first connection member 6.

As shown in FIG. 4, an end part of the second connection member 7 on the Z-axis negative side thereof is fixed to the surface of the recessed part 5a of the share panel 5 on the Z-axis positive side thereof. Thus, the second connection member 7 can function as a reinforcing member of the share panel 5.

Further, as shown in FIG. 4, an end part of the protrusion part 7a of the second connection member 7 on the Z-axis positive side thereof may be in contact with the surface of the housing part 22a of the lower case 22 on the Z-axis negative side thereof through aa third elastic member 32 such as a urethane foam sheet.

Thus, when an impact is applied to the share panel 5 from the Z-axis negative side thereof, the transmission of the impact at the recessed part 5a of the share panel 5 can be stopped not only by the first connection member 6 but also by the second connection member 7, and hence the amount of the EA stroke can be further reduced.

Therefore, a space where the share panel 5 is deformed in the Z-axis direction when an impact is applied to the share panel 5 can be made smaller than that of an ordinary electric storage apparatus, and thus it is possible to contribute to the reduction of the size of the electric storage apparatus 1. Moreover, the bending rigidity of the share panel 5 around the X-axis can be improved, and thus the thickness of the share panel 5 can be reduced. As a result, the weight of the electric storage apparatus 1 can be reduced.

Further, when an impact is applied to the share panel 5 from the Z-axis negative side thereof, a load due to the impact can be released to the intermediate member 11 through the second connection member 7. Therefore, it is not required to make the share panel 5 rigid like a share panel of an ordinary electric storage apparatus, and thus the thickness of the share panel 5 can be reduced. As a result, the weight of the electric storage apparatus 1 can be reduced.

Note that, for example, as shown in FIG. 4, a width dimension W3 of an end part of the protrusion part 7a of the second connection member 7 on the Z-axis positive side thereof in the X-axis direction may be the same as or greater than a width dimension W4 of an end part of the intermediate member 11 on the Z-axis negative side thereof in the X-axis direction. That is, the width dimensions W3 and W4 are lengths in the X-axis direction perpendicular to the Y-axis direction and the Z-axis direction. Thus, when an impact is applied to the share panel 5 from the Z-axis negative side thereof, a load due to the impact can be reliably released to the intermediate member 11 through the second connection member 7.

More preferably, for example, as shown in FIG. 4, the width dimension W3 of the end part of the protrusion part 7a of the second connection member 7 on the Z-axis positive side thereof in the X-axis direction may be substantially the same as the width dimension W4 of the end part of the intermediate member 11 on the Z-axis negative side thereof in the X-axis direction.

Note that, as shown in FIG. 4, as viewed from the Z-axis direction, an end part of the protrusion part 7a of the second connection member 7 on the X-axis positive side thereof may substantially overlap with an end part of the intermediate member 11 on the X-axis positive side thereof, and an end part of the protrusion part 7a of the second connection member 7 on the X-axis negative side thereof may substantially overlap with an end part of the intermediate member 11 on the X-axis negative side thereof.

Thus, as viewed from the Z-axis direction, the protrusion part 7a of the second connection member 7 is disposed between the battery cell sets 17 adjacent to each other in the X-axis direction, and when an impact is applied to the share panel 5 from the Z-axis negative side thereof, the battery cells 10 can be prevented from being pushed up by the second connection members 7.

In the above-described electric storage apparatus 1, as shown in FIGS. 4 to 6, the flange part 21b of the upper case 21 of the pack case 3 of the electric storage apparatus 1 and the flange part 22b of the lower case 22 of the electric storage apparatus 1, for example, may be fixed to a frame-shaped frame 101 of the vehicle 100 from below.

As described above, the electric storage apparatus 1 according to this embodiment includes the first connection member 6 which is disposed between the lower case 22 and the share panel 5 so that at least a part of the first connection member 6 overlaps with the reinforcement member 4 as viewed from the Z-axis direction and connects the lower case 22 to the share panel 5.

Thus, when an impact is applied to the share panel 5 from the Z-axis negative side thereof, the transmission of the impact at the recessed part 5a of the share panel 5 can be stopped by the first connection member 6, and hence the amount of the EA stroke can be reduced.

Therefore, a space where the share panel 5 is deformed in the Z-axis direction when an impact is applied to the share panel 5 can be made smaller than that of an ordinary electric storage apparatus, and thus it is possible to contribute to the reduction of the size of the electric storage apparatus 1. Moreover, the bending rigidity of the share panel 5 around the Y-axis can be improved, and thus the thickness of the share panel 5 can be reduced. As a result, the weight of the electric storage apparatus 1 can be reduced.

Further, when an impact is applied to the share panel 5 from the Z-axis negative side thereof, a load due to the impact can be released to the reinforcement members 4 through the first connection member 6. Therefore, it is not required to make the share panel 5 rigid like a share panel of an ordinary electric storage apparatus, and thus the thickness of the share panel 5 can be reduced. As a result, the weight of the electric storage apparatus 1 can be reduced.

Moreover, in the electric storage apparatus 1 according to this embodiment, in a case where the intermediate member 11 protrudes closer to the Y-axis positive side and the Y-axis negative side than the battery cells 10 do as viewed from the X-axis direction, when an impact is applied to the electric storage apparatus 1 from the Y-axis direction, the intermediate member 11 comes into contact with the protrusion part 4a of the reinforcement member 4 before the battery cell 10 comes into contact with the protrusion part 4a of the reinforcement member 4, and the battery cell 10 can be prevented from being damaged.

Further, in the electric storage apparatus 1 according to this embodiment, when the share panel 5 is connected to the housing part 22a of the lower case 22 through the second elastic member and the third elastic member 32, the share panel 5 can be reliably connected to the housing part 22a of the lower case 22 through the second elastic member and the third elastic member 32, and thus the vibration of the share panel 5 can be suppressed.

Further, in a case where the first elastic member 31 is disposed between the housing part 22a of the lower case 22 and the intermediate member 11 in the electric storage apparatus 1 according to this embodiment, when an impact is applied to the share panel 5 from the Z-axis negative side thereof, a load due to the impact can be reliably released to the intermediate member 11 through the second connection member 7.

The present disclosure is not limited to the above-described embodiments and can be changed as appropriate without departing from the scope and spirit of the present disclosure.

For example, in the above-described embodiments, although the battery cell 10 is stacked in the X-axis direction, it may be stacked in the Y-axis direction, and an arrangement of the intermediate member 11, the first connection member 6, and the second connection member 7 may be changed as appropriate in accordance with the stacking direction of the battery cell 10.

For example, although each of the first connection member 6 and the second connection member 7 according to the above-described embodiments has a substantially hat shape, they may have any shape which enables a load to be transmitted between the lower case 22 and the share panel 5. Further, one of the first elastic member 31, the second elastic member, and the third elastic member 32 may be omitted.

For example, although the first connection member 6 and the second connection member 7 according to the above-described embodiments are fixed to the share panel 5, they may be fixed to the lower case 22, and may not be fixed to the lower case 22 and the share panel 5. In short, the first connection member 6 and the second connection member 7 only need to connect the lower case 22 to the share panel 5 so that a load can be transmitted.

For example, the shapes and the like of the intermediate member 11 and the second connection member 7 according to the above-described embodiments are merely examples, and they have any structure in which, when an impact is applied to the share panel 5 from the Z-axis negative side thereof, a load due to the impact can be released to the intermediate member 11 through the second connection member 7. Further, in the above-described embodiments, although the intermediate member 11 and the second connection member 7 are provided, the intermediate member 11 and the second connection member 7 may be omitted.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An electric storage apparatus comprising:
a first cover;
a plurality of battery cells comprising a pair of electrode terminals disposed above the first cover, one of the pair of electrode terminals being disposed in one of a pair of surfaces that face each other in a first direction and the other of the pair of electrode terminals being disposed on the other one of the surfaces;
a reinforcement member disposed below the electrode terminals and between the plurality of battery cells; and
a second cover disposed below the first cover, wherein
the electric storage apparatus comprises a first connection member configured to connect the first cover to the second cover, the first connection member being disposed between the first cover and the second cover, and
at least a part of the first connection member overlaps with the reinforcement member as viewed from an up-and-down direction.

2. The electric storage apparatus according to claim 1, wherein
the reinforcement member extends in a second direction perpendicular to the first direction and the up-and-down direction,
the first connection member comprises a first protrusion part extending in the second direction and protruding in the up-and-down direction, and
a width dimension of the first protrusion part is the same as or greater than a width dimension of the reinforcement member.

3. The electric storage apparatus according to claim 2, wherein an end part of the first protrusion part in the first direction overlaps with an end part of the reinforcement member in the first direction as viewed from the up-and-down direction.

4. The electric storage apparatus according to claim 1, comprising an intermediate member disposed between at least some of the battery cells arranged in the second direction perpendicular to the first direction and the up-and-down direction,
wherein the intermediate member protrudes in the first direction with respect to the battery cells.

5. The electric storage apparatus according to claim 4, comprising a second connection member configured to connect the first cover to the second cover, the second connection member being disposed between the first cover and the second cover,
wherein at least a part of the second connection member overlaps with the intermediate member as viewed from the up-and-down direction.

6. The electric storage apparatus according to claim 5, wherein
the intermediate member extends in the first direction,
the second connection member comprises a second protrusion part extending in the first direction and protruding in the up-and-down direction, and
a width dimension of the second protrusion part is the same as or greater than a width dimension of the intermediate member.

7. The electric storage apparatus according to claim 6, wherein an end part of the second protrusion part in the second direction overlaps with an end part of the intermediate member in the second direction as viewed from the up-and-down direction.

8. The electric storage apparatus according to claim 7, wherein an elastic member is disposed between the first cover and the second connection member.
